(19) United States
(12) Patent Application Publication
(10) Pub. No.: US 2019/0230206 A1
(43) Pub. Date: Jul. 25, 2019

(54) EXTENDING MOBILE-TO-VEHICLE APIS TO THE CLOUD

(71) Applicant: FORD GLOBAL TECHNOLOGIES, LLC, Dearborn, MI (US)

(72) Inventors: Elizabeth HALASH, Warren, MI (US); Stefan BANKOWSKI, Royal Oak, MI (US); Robin Mathew KURIAN, Farmington Hills, MI (US); Jeffrey HU, Ann Arbor, MI (US)

(21) Appl. No.: 15/877,695

(22) Filed: Jan. 23, 2018

(51) Int. Cl. H04M 1/60; H04W 8/24

(52) U.S. Cl. CPC H04M 1/6075; H04W 8/24

(57) ABSTRACT

A server is programmed to receive an application command from a hosted application executed by a second server, generate a simulated mobile device command indicating a function specified by the application command, and send the simulated mobile device command to a telematics controller of a vehicle, to cause the vehicle to execute the application command using a device link interface configured for communication between the vehicle and mobile devices local to the vehicle.

### TECHNICAL FIELD

Aspects of the disclosure generally relate to extension of application programming interfaces (API) used to facilitate communication between mobile devices locally networked to vehicles to support remote communication through a wide-area network.

### BACKGROUND

A user may pair his or her phone to a head unit of a vehicle. Once paired, the phone may be able to communicate information with the head unit. For instance, the phone may stream audio from an Internet radio service to the head unit for playback within the vehicle. Or, the phone may execute a navigation application to provide directions to the vehicle.

### SUMMARY

In one or more illustrative embodiments, a system includes a server programmed to receive an application command from a hosted application executed by a second server, generate a simulated mobile device command indicating a function specified by the application command, and send the simulated mobile device command to a telematics controller of a vehicle, to cause the vehicle to execute the application command using a device link interface configured for communication between the vehicle and mobile devices local to the vehicle.

In one or more illustrative embodiments, a system includes a head unit controller; a telematics control unit (TCU) programmed to receive a receive a command from a server, and a gateway programmed to receive the command from the TCU and forward the command to the head unit controller; wherein the gateway is programmed to execute the command using a device link interface configured for communication between the vehicle and mobile devices local to the vehicle.

In one or more illustrative embodiments, a method includes sending a simulated mobile device command, indicating a function specified by the application command received from a mobile application hosted by an application server, to a telematics controller of a vehicle, to cause the vehicle to execute the application command using a device link interface configured for communication between the vehicle and mobile devices local to the vehicle.

### BRIEF DESCRIPTION OF THE DRAWINGS

FIG. 1 illustrates an example portion of a vehicle including a head unit controller configured to provide telematics services to the vehicle;

FIG. 2 illustrates an example topology for messaging within various components of the vehicle via a gateway;

FIG. 3 illustrates an example system for sending mobile commands to a vehicle from an application server;

FIG. 4 illustrates an example process for using a vehicle API server to provide telematics services to a vehicle from the application server; and

FIG. 5 illustrates an example process for providing telematics services to a vehicle from a hosted mobile application executed by an application server via a vehicle API server.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Many current telematics solutions require a physical connection between a vehicle infotainment system and a mobile device of a user. Due to differences in mobile device hardware, software, and implementation, there can often be issues with initiating or maintaining the connection between mobile device and vehicle. This can cause undesirable effects to mobile applications, resulting in perceived quality issues and user frustration. Additionally, current systems reduce available use cases to those that can occur while a user is physically located within a vehicle with a mobile device connected to the vehicle infotainment system.

Using the current mobile app-to-vehicle functionality, individual applications executed by a mobile device registered with the head unit may send commands to control the HMI of the infotainment system, as well as request vehicle data via the same registration connection. This functionality may be extended to applications that are executed by a cloud server instead of on the mobile device. For instance, cloud-based applications can be configured to send commands via a web protocol, e.g., via hypertext transfer protocol (HTTP). Those commands may be received by an API gateway, which maps the commands to current in-vehicle commands the infotainment can accept and understand. These mapped commands may then be forwarded from the API gateway to a modem of the vehicle. The modem may register with the head unit, similar to how a mobile application does, to allow the modem to send commands to actuate events in the vehicle, such as HMI notifications, or a change in vehicle seat, radio, or climate settings, or request data back from the vehicle to be sent to the cloud server.

Accordingly, a physical (and local to the vehicle) mobile device no longer needs to be connected to a vehicle head unit (e.g., via BLUETOOTH, USB, Wi-Fi, etc.). By de-coupling these two physical items and introducing a cloud component, device-connection issues may be removed, and the ability to send commands to a vehicle at any time may be introduced. Moreover, by using the cloud server, application functionality may be performed using the vehicle whether or not a user is physically located within the vehicle with a mobile device connected. Yet, head unit functionality, commands, and responses may remain the same, reducing the amount of engineering re-work required to add cloud-based application support. Instead, the head unit may connect to the modem component of the vehicle as if the modem were another mobile device capable of executing applications. Thus, instead of using BLUETOOTH or USB, the connection to the head unit may be implemented via the internal network of the vehicle. Further aspects of the disclosure are discussed in detail below.

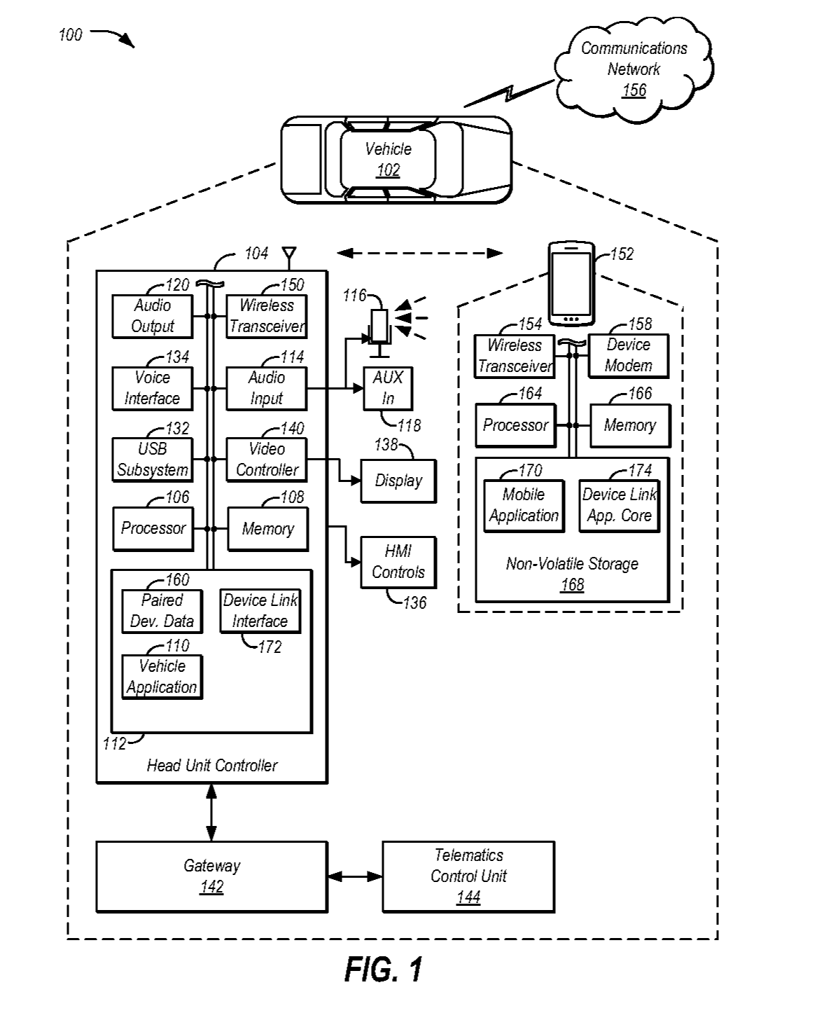

FIG. 1 illustrates an example portion of a vehicle 102 including a head unit controller 104 configured to provide telematics services to the vehicle 102. The vehicle 102 may include various types of passenger vehicle, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. The head unit controller 104 may be in communication with a mobile device 152 and a gateway 142. In an example, the system 100 may include the SYNC system manufactured by The Ford Motor Company of Dearborn, Mich. It should be noted that the illustrated system 100 is merely an example, and more, fewer, and/or differently located elements may be used.

A head unit controller 104 may include one or more processors 106 configured to perform instructions, commands, and other routines in support of the processes described herein. For instance, the head unit controller 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the head unit controller 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The head unit controller 104 may be provided with various features allowing the vehicle occupants to interface with the head unit controller 104. For example, the head unit controller 104 may include an audio input 114 configured to receive spoken commands from vehicle occupants through a connected microphone 116, and an auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The head unit controller 104 may also provide one or more audio outputs 120 to an input of an audio module (not illustrated) having audio playback functionality. In other examples, the head unit controller 104 may provide the audio output 120 to an occupant through use of one or more dedicated speakers (not illustrated). The audio module may include an input selector configured to provide audio content from a selected audio source to an audio amplifier for playback through vehicle speakers or headphones (all not illustrated). The audio sources may include, as some examples, decoded amplitude modulated (AM) or frequency modulated (FM) radio signals, and audio signals from compact disc (CD) or digital versatile disk (DVD) audio playback. The audio sources may also include audio received from the head unit controller 104, such as audio content generated by the head unit controller 104, audio content decoded from flash memory drives connected to a universal serial bus (USB) subsystem 132 of the head unit controller 104, and audio content passed through the head unit controller 104 from the microphone 116 or auxiliary audio input 118.

The head unit controller 104 may utilize a voice interface 134 to provide a hands-free interface to the head unit controller 104. The voice interface 134 may support speech recognition from audio received via the microphone 116 according to a standard grammar describing available command functions, and voice prompt generation for output. The voice interface 134 may utilize probabilistic voice recognition techniques using the standard grammar in comparison to the input speech. In many cases, the voice interface 134 may include a standard user profile tuning for use by the voice recognition functions to allow the voice recognition to be tuned to provide good results on average, resulting in positive experiences for the maximum number of initial users. In some cases, the system may be configured to temporarily mute or otherwise override the audio source specified by the input selector 124 when an audio prompt is ready for presentation by the head unit controller 104 and another audio source is selected for playback.

The head unit controller 104 may also receive input from human-machine interface (HMI) controls 136 configured to provide for occupant interaction with the vehicle 102. For instance, the head unit controller 104 may interface with one or more buttons or other HMI controls configured to invoke functions on the head unit controller 104 (e.g., steering wheel audio buttons, a push-to-talk button, instrument panel controls, etc.). The head unit controller 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

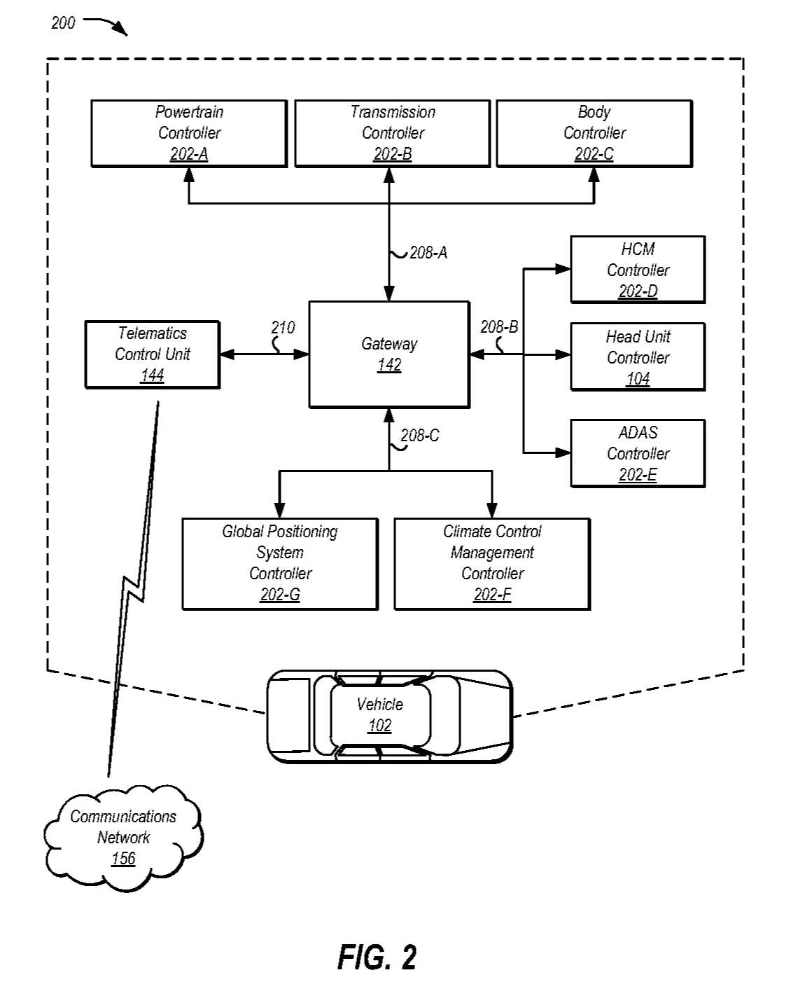

The head unit controller 104 may be further configured to communicate with other components of the vehicle 102 via a gateway 142. Further aspects of the operation of the gateway 142 are described in further detail below with respect to FIG. 2.

The head unit controller 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the head unit controller 104. In many examples, the head unit controller 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the head unit controller 104 may communicate with the mobile device 152 over a wired connection, such as via a USB connection between the mobile device 152 and the USB subsystem 132. In some examples, the mobile device 152 may be battery powered, while in other cases the mobile device 152 may receive at least a portion of its power from the vehicle 102 via the wired connection. In some cases, the mobile device 152 may be powered via wireless inductive charging.

A communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the head unit controller 104 may be identified by the head unit controller 104 according to paired device data 160 maintained in the storage medium 112. The paired device data 160 may indicate, for example, the unique device identifiers of mobile devices 152 previously paired with the head unit controller 104 of the vehicle 102, such that the head unit controller 104 may automatically reconnected to the mobile devices 152 referenced in the paired device data 160 without user intervention.

When a mobile device 152 that supports network connectivity is paired with and connected to the head unit controller 104, the mobile device 152 may allow the head unit controller 104 to use the network connectivity of the device modem 158 to communicate over the communications network 156 with a telematics server or another remote computing device. In one example, the head unit controller 104 may utilize a data-over-voice plan or data plan of the mobile device 152 to communicate information between the head unit controller 104 and the communications network 156. Additionally or alternately, the head unit controller 104 may utilize a telematics control unit 144 to communicate information between the head unit controller 104 and the communications network 156, without use of the communications facilities of the mobile device 152.

Similar to the head unit controller 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the head unit controller 104 via the wireless transceiver 154 and with other network services via the device modem 158.

For instance, the head unit controller 104 may include a device link interface 172 to facilitate the integration of functionality of the mobile applications 170 configured to communicate with a device link application core 174 executed by the mobile device 152. In some examples, the mobile applications 170 that support communication with the device link interface 172 may statically link to or otherwise incorporate the functionality of the device link application core 174 into the binary of the mobile application 170. In other examples, the mobile applications 170 that support communication with the device link interface 172 may access an application programming interface (API) of a shared or separate device link application core 174 to facilitate communication with the device link interface 172.

The integration of functionality provided by the device link interface 172 may include, as an example, the ability of mobile applications 170 executed by the mobile device 152 to incorporate additional voice commands into the grammar of commands available via the voice interface 134. The device link interface 172 may also provide the mobile applications 170 with access to vehicle information available to the head unit controller 104 via the gateway 142. The device link interface 172 may further provide the mobile applications 170 with access to the vehicle display 138. An example of a device link interface 172 may be the SYNC APPLINK component of the SYNC system provided by the Ford Motor Company of Dearborn, Mich. Other examples of device link interfaces 172 may include MIRRORLINK, APPLE CARPLAY, and ANDROID AUTO.

FIG. 2 illustrates an example topology 200 for messaging within various components of the vehicle 102 via the gateway 142. Each electronic control unit (ECU) 202 may be connected to one of a plurality of subnets 208. The telematics control unit (TCU) 144 is included to facilitate communication between various components of the vehicle 102 and the communications network 156. The TCU 144 may be connected to a backbone 210 portion of the topology 200 and may communicate with the ECUs 202 via the gateway 142. While an example topology 200 is shown in FIG. 2, the example components as illustrated are not intended to be limiting. Indeed, the topology 200 may have more or fewer components, and additional or alternative components and/or implementations may be used. As an example, the ECUs 202 and the TCU 144 may each be connected to one or more same or different types of nodes as the subnets 208 and the backbone 210.

The ECUs 202 may include various hardware and software components configured to monitor and manage various vehicle functions. The ECUs 202 may, accordingly, include one or more processors (e.g., microprocessors) (not shown) configured to execute firmware or software programs stored on one or more storage devices (not shown) of the ECUs 202. While the ECUs 202 are illustrated as separate components, the vehicle ECUs 202 may share physical hardware, firmware, and/or software, such that the functionality from multiple ECUs 202 may be integrated into a single ECU 202, and the functionality of various such ECUs 202 may be distributed across a plurality of ECUs 202.

The ECUs 202 may include a powertrain controller 202-A configured to manage operating components related to one or more vehicle sources of power, such as engine, battery, and so on, a transmission controller 202-B configured to manage power transfer between vehicle powertrain and wheels, a body controller 202-C configured to manage various power control functions, such as exterior lighting, interior lighting, keyless entry, remote start, and point of access status verification, a headlamp control module (HCM) 202-D configured to control light on/off settings, advanced driver assistance systems (ADAS) 202-E such as adaptive cruise control or automated braking, a climate control management controller 202-F configured to monitor and manage heating and cooling system components (e.g., compressor clutch, blower fan, temperature sensors, etc.), a global positioning system (GPS) controller 202-G configured to provide vehicle location information. The head unit controller 104 may also be one of the ECUs 202, as shown. It should be noted that these are merely examples and vehicles 102 having more, fewer, or different ECUs 202 may be used.

The TCU 144 may include one or more processors (not shown) (e.g., microprocessors) configured to execute firmware or software programs stored on one or more respective storage devices of the TCU 144. The TCU 144 may include a modem or other network hardware to facilitate communication between the vehicle 102 and one or more networks external to the vehicle 102. These external networks may include the Internet, a cable television distribution network, a satellite link network, a local area network, a wide-area network, and a telephone network, as some non-limiting examples.

The gateway 142 may be configured to facilitate data exchange between vehicle ECUs 202. The gateway 142 may be further configured to facilitate data exchange between the vehicle ECUs 202 and the TCU 144 located on the backbone 210. In an example, the vehicle ECUs 202 and the TCU 144 may communicate with the gateway 142 using CAN communication protocol, such as, but not limited to, a high-speed (HS) CAN, a mid-speed (MS) CAN, or a low-speed (LS) CAN. Different subnets 208 may utilize different CAN protocol speeds. In an example, one or more of the subnets may implement HS-CAN, while one or more other subnets 208 may implement MS-CAN. In yet other examples, the gateway 142 may be configured to facilitate communication using one or more of an Ethernet network, a media oriented system transfer (MOST) network, a FlexRay network, or a local interconnect network (LIN).

One or more of the subnets 208 may define a main subnet, which may be referred to as a backbone 210. The backbone 210 may include a portion of the topology 200 configured to serve as a joining point of communication for the other subnets 208 of the vehicle 102. Accordingly, the backbone 210 may be configured to manage and route data traffic in a greater volume than that provided via the other subnets 208. Using the message processing features of the gateway 142, the gateway 142 may be configured to transmit message frames between the TCU 144 located on the backbone 210 and the one or more of the vehicle ECUs 202 located on the other subnets 208.

The gateway 142 may be configured to identify on which subnet 208 each of the ECUs 202 and TCU 144 is located. This may be accomplished according to a corresponding physical network address of the ECUs 202 and TCU 144. In an example, in response to receiving a request to route a message to a given ECU 202 or the TCU 144, the gateway 142 may query a storage to identify a network address corresponding to the ECU 202 or the TCU 144. For instance, the gateway 142 may include a storage configured to store the network addresses, as well as a routing schema defining which messages are routed to which subnets 208 and/or backbone 210. This routing may be determined by the gateway 142 based on predefined parameters included in the message, such as a type of message and/or identifiers of the ECUs 202 or the TCU 144 that designate the source and/or target of the message.

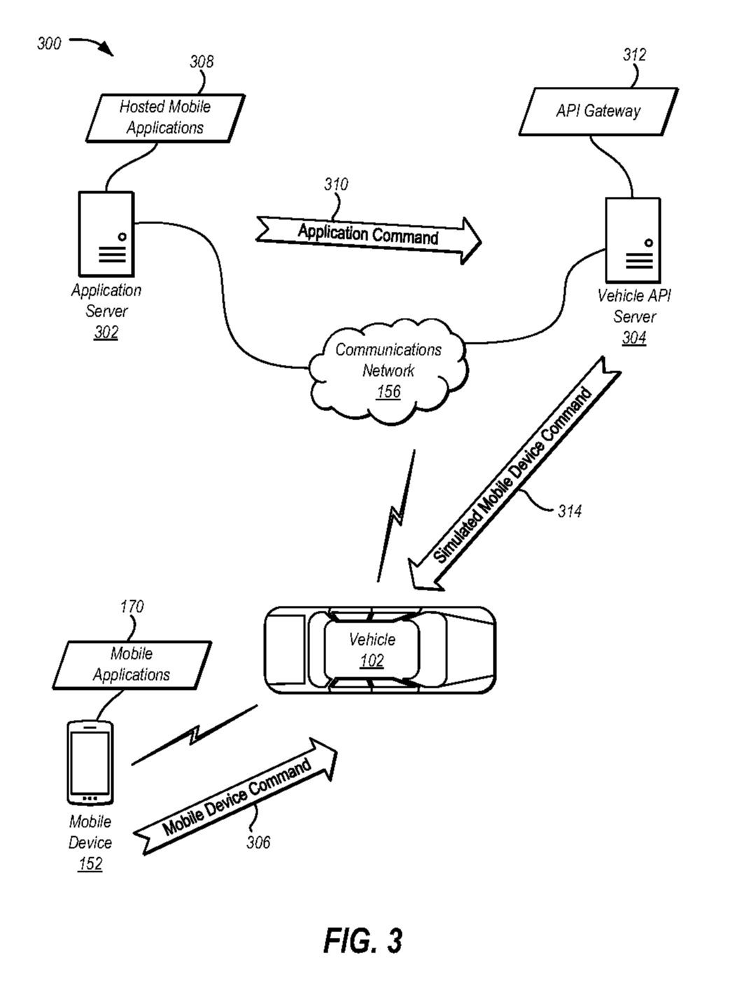

FIG. 3 illustrates an example system 300 for sending mobile device commands 306 to a vehicle 102 from an application server 302. As shown, the vehicle 102, an application server 302, and a vehicle API server 304 may be configured to communicate over a communications network 156. The application server 302 may be configured to execute a hosted mobile application 308 to send an application command 310 to the vehicle API server 304. The API server 304 may be configured to execute an API gateway 312. Responsive to receipt of the application command 310, the API server 304 may be configured to utilize the API gateway 312 to send a simulated mobile device command 314 to the vehicle 102. As explained in greater detail below, the simulated mobile device command 314 may be processed by the vehicle 102 as if the simulated mobile device command 314 was sent from a mobile application 170 of a mobile device 152 connected directly to the vehicle 102. While an example system 300 is shown in FIG. 3, the example components as illustrated are not intended to be limiting. Indeed, the system 300 may have more or fewer components, and additional or alternative components and/or implementations may be used.

The application server 302 may include various types of computing apparatus, such as a computer workstation, a server, a desktop computer, a virtual server instance executed by a mainframe server, or some other computing system and/or device. Computing devices, such as the application server 302, generally include a memory to which computer-executable instructions and data may be loaded from a storage, where the instructions may be executable by one or more processors of the computing device. Such instructions and other data may be stored using a variety of computer-readable media. The computer-readable storage (also referred to as a processor-readable medium or storage) includes any non-transitory (e.g., tangible) medium that participates in providing data (e.g., instructions) that may be read by a computer (e.g., by the processor of the analysis server). In general, processors receive instructions, e.g., from the memory via the computer-readable storage medium and execute these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Java Script, Perl, PL/SQL, etc.

Similar to the application server 302, the vehicle API server 304 may include various types of computing apparatus (not shown) including a memory on which computer-executable instructions may be maintained, where the instructions may be executable by one or more processors of the computing device.

As mentioned above, the mobile device 152 may be configured to execute mobile applications 170. These mobile applications 170 may communicate with the vehicle via the device link interface 172 to facilitate the integration of functionality of the mobile applications 170 configured to communicate with a device link application core 174 executed by the mobile device 152. The mobile applications 170 may utilize these interfaces to send mobile device commands 306 to control aspects of the vehicle 102, as well as to receive mobile device commands 306 from the head unit controller 104 (reverse flow not shown).

The application server 302 may similarly host mobile applications 308 that are executed by the application server 302 instead of by the mobile device 152, but that are also configured to provide services to the vehicle 102. These hosted mobile applications 308 may be configured to send commands via a web protocol (e.g., HTTP), rather than via a wireless or other protocol connection between the mobile device 152 and the vehicle 102.

The vehicle API server 304 may be configured to execute the API gateway 312. The API gateway 312 may be an application installed to the vehicle API server 304 and programmed to cause the vehicle API server 304 to receive the application commands 310 from the application server 302, verify security aspects of the application commands 310, and generate simulated mobile device commands 314 to be sent to the vehicle 102.

The simulated mobile device commands 314 may be received by the TCU 144 of the vehicle 102, identified as being simulated mobile device commands 314 by the TCU 144, and used to control the vehicle 102 similar to how the vehicle 102 may be controlled using mobile device commands 306. Thus, the TCU 144 may, in effect, act in place of the paired mobile device 152 in the serving of application commands to the head unit controller 104.

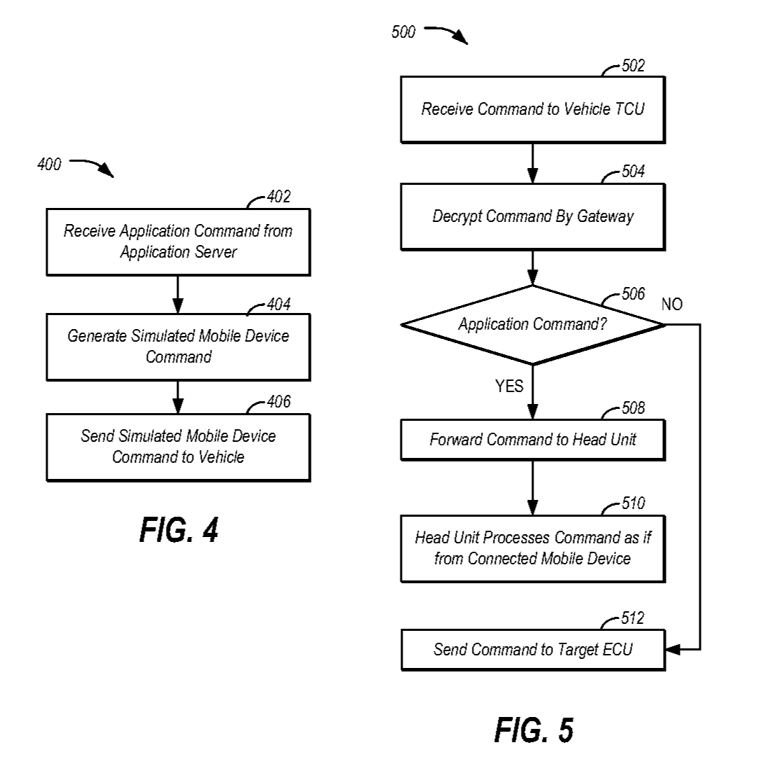

FIG. 4 illustrates an example process 400 for using a vehicle API server 304 to provide telematics services to a vehicle 102 from the application server 302. In an example, the process 400 may be performed using the systems described above with respect to FIGS. 1-3.

At 402, the vehicle API server 304 receives an application command 310 from a hosted mobile application 308 executed by the application server 302. In an example, the application command 310 may be included in a web request such as an HTTP request. The application command 310 may be sent over the communication network 156, which may be a wide-area network such as the Internet, and may be received by a cloud API of the vehicle API server 304. Examples of the cloud API include interfaces for controlling various vehicle functions (e.g., lock, unlock, star/stop the engine, send a destination to the in-vehicle navigation system, control the climate, radio, other in-vehicle settings, etc.). The cloud API may additionally or alternately include interfaces for receiving vehicle information (e.g., global position of the vehicle 102, vehicle 102 speed, vehicle health status, vehicle state, etc.).

The target vehicle 102 may be identified in the application command 310 by vehicle VIN. In another example, the target vehicle 102 may be identified in the application command 310 according to an obfuscated VIN to provide a different, though unique vehicle ID to third parties. This still enables a single, unique vehicle 102 to be controlled, but removes privacy concerns related to sharing VIN with outside, third party entities.

At operation 404, the vehicle API server 304 generates a simulated mobile device command 314 responsive to receipt of the application command 310. In an example, the API gateway 312 performs one or more checks on the received application command 310. These checks may include, as some examples, identity, security, permission, capability, and subscription checks.

For instance, the API gateway 312 may store or have access to vehicle build configuration information. This information may be indexed by VIN or other vehicle identifier, and may indicate the equipment installed to the vehicle 102 at build time. The installed equipment may affect which functions can be actuated. In an example, if the vehicle 102 does not have power seats, then a “power seat” app may be unable to function or send commands to this example vehicle 102. The API gateway 312 may accordingly check to ensure that the target vehicle 102 of the received application command 310 has the equipment to execute the request.

In another example, the API gateway 312 may perform identity checks to verify that the third-party caller application server 302 is indeed who it says it is. For instance, the identity checks may use an authentication mechanism such as OAuth 2.0 credentials to validate the application server 302 and/or the hosted mobile application 308 of the application server 302.

As yet another example, the API gateway 312 may perform permission checks. For instance, the API gateway 312 may implement a policies architecture that enables the vehicle API server 304 to define permissions per third party partner per API, as well as allow the user to additionally allow category-based access to third parties to access their personally-owned or temporarily-used vehicle 102.

In some cases, certain in-vehicle infotainment features may require a user-based subscription to be enabled. For example, an online traffic feature providing current traffic conditions information may require a subscription. Thus, for some APIs, the status of the subscription for a particular feature may be checked by the API gateway 312 before a command is sent to the vehicle 102. If the subscription is inactive, the API request would be unable to be completed.

The API gateway 312 may further map the cloud API to a device link API and forward the mapped message as a simulated mobile device command 314 to be encrypted for transport to the vehicle 102. The API gateway 312 may accordingly perform security by the encryption of messages between the cloud and the vehicle 102.

The vehicle API server 304 sends the simulated mobile device command 314 to the vehicle 102 at 406. In an example, the vehicle API server 304 sends the simulated mobile device command 314 to the vehicle 102 over the communications network 156, to be received by the TCU 144 of the vehicle 102. After operation 406, the process 400 ends.

FIG. 5 illustrates an example process 500 for providing telematics services to the vehicle 102 from the hosted mobile application 308 executed by the application server 302 via a vehicle API server 304.

At 502, the TCU 144 of the vehicle 102 receives an encrypted command from the vehicle API server 304. In an example, the command is a simulated mobile device command 314 as sent via the process 400. In another example, the command is another form of command, such as a door unlock command, that is not sent based on a hosted mobile application 308. The TCU 144 may send the simulated mobile device command 314 to the gateway 142 for processing.

At operation 504, the gateway 142 decrypts the command. For instance, the simulated mobile device command 314 from the vehicle API server 304 contains another command for the in-vehicle telematics system. The gateway 142 does not understand the included command. However, the gateway 142 decrypts the simulated mobile device command 314 to unpack the included command.

The gateway 142 determines whether the command is a simulated mobile device command 314 at 506. In an example, the command may include a field or other identifier indicating that the command is a device link command intended for the head unit controller 104. If the command is determined to be a simulated mobile device command 314, control passes to operation 508. Otherwise, control passes to operation 512. Accordingly, the gateway 142 will know to forward the command inside the simulated mobile device command 314 to the head unit controller 104 after it unpacks the message from the vehicle API server 304.

At 508, the gateway 142 forwards the simulated mobile device command 314 to the head unit controller 104. In an example, the head unit controller 104 may receive the message over one of the subnets 208.

At operation 510, the head unit controller 104 processes the simulated mobile device command 314. In an example, the head unit controller 104 may forward the simulated mobile device command 314 to the device link interface 172 as if the simulated mobile device command 314 was received from a connected mobile device 152. Accordingly, the head unit controller 104 may process the simulated mobile device command 314 to provide telematics functions, despite the command not having originated from a mobile device located within the vehicle 102 cabin. After operation 510, the process 500 ends.

At 512, the gateway 142 forwards the command to the target ECU 202 specified by the command. Accordingly, commands other than simulated mobile device command 314 may continue to be processed by the gateway 142 without being affected by the functionality of the simulated mobile device commands 314. After operation 512, the process 500 ends.

Computing devices described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a server programmed to:
receive, over a web protocol via a cloud application programming interface (API), an application command from a hosted application executed by a second server,
generate a simulated mobile device command indicating a function specified by the application command in a format of a device link API of a device link interface of a head unit controller of a vehicle, the device link interface configured for processing commands sent between the vehicle and mobile devices directly connected to the vehicle over a local network connection to the vehicle, and
send the simulated mobile device command to a modem of a telematics controller of the vehicle, the modem being registered with the head unit controller of the vehicle as a mobile device capable of executing applications using the device link API, to cause the vehicle to execute the application command using the device link interface of the head unit controller.

2. The system of claim 1, wherein the device link interface is executed by the head unit controller of the vehicle, and the application command includes a request to display information to a screen of a head unit controller of the vehicle.

3. The system of claim 1, wherein the server is further programmed to encrypt the simulated mobile device command in accordance with an encryption protocol supported by a gateway of the vehicle.

4. The system of claim 1, wherein the server is further programmed to indicate in the simulated mobile device command that the simulated mobile device command is intended for the device link interface.

5. The system of claim 1, wherein the hosted application hosted by the second server is a navigation application or an online traffic application.

6. The system of claim 1, wherein the server is further programmed to confirm that that function is supported by a build configuration of the vehicle.

7. The system of claim 1, wherein the function requires a subscription of the vehicle to a service, and the server is further programmed to confirm that the vehicle is subscribed to the service.

8. A vehicle comprising:
a head unit controller;
a telematics control unit (TCU) programmed to receive a command from a server, the TCU having a modem registered with the head unit controller as a mobile device capable of executing applications with the head unit controller; and
a gateway programmed to receive the command from the TCU and forward the command to the head unit controller,
wherein the head unit controller is programmed to execute the command using a device link interface configured for processing commands sent between the vehicle and mobile devices registered with the TCU and directly connected to the vehicle over a local network connection to the vehicle.

9. The vehicle of claim 8, wherein the head unit controller is further programmed to execute a second command using the device link interface, the second command being received from a mobile device within the vehicle, the mobile device being a smartphone directly connected to the head unit controller.

10. The vehicle of claim 8, wherein the command indicates that the command is a simulated mobile device command intended for the device link interface.

11. The vehicle of claim 8, wherein the command is received from a hosted mobile application executed by an application server in communication with the server.

12. The vehicle of claim 8, wherein the command is a command from a navigation application, a vehicle unlock application, or an online traffic application hosted by the server.

13. A method comprising:
registering, with a head unit controller of a vehicle, a modem of a telematics controller of the vehicle as a device capable of executing applications with a device link interface of the head unit controller, the device link interface configured for processing commands sent between the vehicle and smartphones directly connected to the vehicle over a local network connection to the vehicle; and
sending a simulated mobile device command, indicating a function specified by an application command received from a mobile application hosted by an application server, to the telematics controller, to cause the vehicle to execute the application command using the device link interface.

14. The method of claim 13, wherein the device link interface is executed by a head unit controller of the vehicle, and the application command includes a request to display information to a screen of a head unit controller of the vehicle.

15. The method of claim 13, wherein the application server is further programmed to encrypt the simulated mobile device command.

16. The method of claim 13, wherein the application server is further programmed to indicate in the simulated mobile device command that the simulated mobile device command is intended for the device link interface.

17. The method of claim 13, wherein the mobile application is a navigation application, a vehicle unlock application, or an online traffic application.

18. The system of claim 1, wherein the web protocol is hypertext transfer protocol (HTTP).
